(19) United States
(12) Patent Application Publication
(10) Pub. No.: US 2005/0240582 A1
(43) Pub. Date: Oct. 27, 2005

(54) Processing data in a computerised system

(75) Inventors: Kimmo Hatonen, Helsinki (FI); Markus Miettinen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/893,601

(22) Filed: Jul. 19, 2004

(30) Foreign Application Priority Data
Apr. 27, 2004 (GB) 0409364.7

(51) Int. Cl. G06F 17/30

(52) U.S. Cl. 707/6

(57) ABSTRACT

In a computerized system, a frequent pattern is provided from patterns of data. A first checksum is then assigned for the frequent pattern. Upon an occurrence of the frequent pattern in data, a second checksum is computed based on information regarding the first checksum and information regarding the occurrence of the frequent pattern in the data.

### BACKGROUND OF THE INVENTION

1. Field of the Invention

The present invention relates generally to computerised systems, and in particular to processing of data provided in a computerised system. Data may need to be processed for example for the purposes of searching and other data mining operations and/or storing data in a computerised system.

2. Description of the Related Art

Computerised systems are known. In general, a computerised system may be provided by any system facilitating automated data processing. For example, a computerised system may be provided by a stand-alone computer or a network of computers or other data processing nodes and equipment associated with the network, for example servers, routers and gateways. A computerised system may also be provided by any other equipment or system provided with the capability of processing data. Further examples of computerised systems thus include controllers and other nodes of a communication network or any other system, user equipments, such as mobile phones, personal data assistants, game stations, health and other monitoring equipment and so on. Furthermore, communication networks, for example open data networks such as the Internet, or public telecommunication networks or closed networks such as local area networks are also computerised systems.

A computerised system commonly produces various information which may be analysed or otherwise processed. The information may be processed for various purposes, for example for analysing the operation of the computerised system, for charging the use of the system and so on. The information may also need to be stored for later use or otherwise processed, for example analysed or monitored later on.

A good illustrative example of information produced during operation of a computerised system is log data. Log data commonly describes the behaviour of a system and/or components thereof and relevant events that the system is involved with. Log data files are seen as an important source of information for monitoring and/or analysis of a computerised system since the log data assist in understanding what has happened and/or is happening in the system. Examples of users of log data include system operators, software developers, security personnel and so on.

Computerised systems are constantly evolving. The number and variety of services and functions provided by means of computerised systems, for example by means of a computerised communication network, is also increasing. Functionalities of nodes of a computerised network are also becoming increasingly complex. This alone leads to increase in the volumes of various data, such as log data, alarm data, measurement data, extended mark-up language (XML) messages, and XML-tagged structured measurement data to mention a few examples. Furthermore, more powerful tools are developed for collecting information from a computerised system, for example from a node or a plurality of nodes of a communication network or a user equipment.

The amount of collected log data or other data for analysis may even become too high for it to be handled efficiently with the existing analysing tools. The increase in complexity of the computerised systems and in the amount of data collected thus sets a substantial challenge for data storage or archiving systems.

An example of these challenges relates to the efficient use of storage space. That is, the storage space that is needed to maintain all data that the users may feel as necessary should be used as efficiently as possible. At the same time searching and extracting appropriate data should be made easy and simple to perform.

To save storage space the log data files and other data files are typically stored in compressed form. Compression may be performed by means of an appropriate compression algorithm, for example by means of an appropriate sequential compression algorithm. When the files need to be queried or a regular expression search for relevant lines needs to be made, the whole archive may need to be decompressed in certain applications before a query or search is possible. This slows down the searching, and requires additional processing i.e. decompression.

Searching for data patterns is a method of searching for data. A data pattern can be defined as a set of attribute values or symbols. A data pattern search may comprise, for example, a search for a set of attribute values on a database row or a set of log entry types.

Published US patent application publication nr 2002/0087935 A1 discloses a method and apparatus for finding variable length data patterns within a data stream. In the disclosed method an incremental checksum is used to find a character pattern from a data stream. A checksum is counted for each byte such that a first checksum is counted for a first byte and then an incremental checksum is counted for the first checksum and a second byte, and so on. The results are then compared to the checksum of the data pattern that is the subject of the search. However, the published U.S. application 2002/0087935 only discloses computing of checksums for subsequent entries, and cannot be used for entries with more than one value. Furthermore, the disclosed method can only be used for searching of previously known patterns. This may not be appropriate in all applications, since it may well be that the data pattern to be searched is not known beforehand.

Another search concept is based on so called closed sets. The term ‘closed set’ refers to a frequent pattern of data which does not have any super patterns of data that share the same frequency, i.e. to a union of all data sets in a closure. It shall be appreciated, though, that some of the sub-patterns of a closed set may have larger frequencies than the closed set.

A frequent pattern is understood to refer to a pattern whose frequency is greater than or at least as great as a frequency threshold. A frequent pattern may be formed by frequent sets of data or frequent episodes. A set commonly refers to a set of attribute values or binary attributes. A transaction may be a set of one or more database tuples or rows. For example, a frequent set may be a set of attribute values that occur frequently enough together on a database row or in a transaction to satisfy a threshold criteria. The term frequent episode commonly refers to a sequence of event types that occur close together in a stream of events. In this context, events can be understood to occur close together, if they are contained in the same transaction-like unit of events. Such transaction-like units of events can be, for example, buckets of related events or windows on the event stream consisting of succeeding events. Alternatively, frequent episodes can be seen to occur in an event stream as so called minimal occurrences. A frequent episode may also be provided by a sequence of log entry types occurring often together. Event types may be, for example, atomary symbols or clauses or parameterised propositions or predicates. An ‘event type’ can be something fairly simple, for example a distinct and/or static kind of log message, or, something fairly complicated, for example a message with a plurality of varying parameters.

Various techniques are known for finding frequent pattern closures from data. Examples of these include algorithms such as ‘Close’ described by Nicolas Pasquier et al. in an article ‘Efficient mining of association rules using closed itemset lattices’ published in Information Systems, vol. 24 No 1, 1999, page 34. ‘Close’ and its variations maintain a list of items that occur always together with a candidate itemset. After a database pass, i.e. a scan over the database, all items occurring together are combined and the combined set is expanded for the next database pass where candidate support is calculated for the combined set. A search method known as ‘CLOSET’ is another example of this type of approach.

Another possible method is to maintain an inverted list of database transaction identifiers (TIDs) of those transactions where a candidate occurs. After each database scan it is possible to combine all candidate sets with identical inverted TID lists. The combined candidate set may then be expanded for the next support calculation round.

The above described searching methods use lists or sets. The number of candidates for which the list or sets have to be matched can easily become substantially large. This may be especially the case with the complex computerised systems and better data collection tools. Updating or checking of list memberships may also take a lot of time and/or require substantial data processing capacity. A problem with these approaches thus relates to the efficiency of maintaining and matching the lists, for example lists of related items or lists of transaction identifiers.

### SUMMARY OF THE INVENTION

Embodiments of the present invention aim to address one or several of the above problems.

According to one embodiment of the present invention, there is provided a method for processing data in a computerised system. The method comprises the steps of providing a frequent pattern of data from patterns of data, assigning a first checksum for the frequent pattern of data, detecting an occurrence of the frequent pattern of data in data provided in a computerised system, and computing a second checksum based on information regarding the first checksum and information regarding the occurrence of the frequent pattern of data in said data.

According to another embodiment there is provided a processor for a computerised system. The processor is configured to provide a frequent pattern from patterns of data, to assign a first checksum for the frequent pattern, to monitor for an occurrence of the frequent pattern in data, and to compute a second checksum based on information regarding the first checksum and information regarding the occurrence of the frequent pattern in said data.

In a specific form of the above embodiments further checksums are computed iteratively for frequent patterns of data with occurrences in said data based on information regarding previous checksums and information regarding occurrences of the frequent patterns.

The embodiments of the invention may provide a feasible solution for optimizing data mining, for example for speeding up and/or making tractable analysis of large data sets with many attributes. Results of searches may be used in storing data efficiently. The embodiments may generate an efficient representation of data which may then be used in searching and/or storing of data. It is not necessary to know the data patterns to be searched beforehand. Certain embodiments may be used in ensuring that methods such as the Queryable Lossless Log Compression (QLC; A method for semantic compression of a log database table) and Comprehensive Log Compression (CLC; A method for summarizing and compacting of log data) are able to scale up with larger data sets with more database fields included. Certain embodiments may also be provide advantage in storing log data tables in compressed space, in finding associations and frequent episodes.

### BRIEF DESCRIPTION OF DRAWINGS

For better understanding of the present invention, reference will now be made by way of example to the accompanying drawings in which:

FIG. 1 shows an example of a part of a database;

FIG. 2 shows an example of a computerised system;

FIG. 3 is a flowchart illustrating the operation of one embodiment;

FIG. 4 is a flowchart illustrating the operation of a more specific embodiment;

FIG. 5 shows a schematic example of a data set;

FIG. 6 shows an exemplifying checksum computation entity; and

FIG. 7 shows a schematic example of another data set.

### DETAILED DESCRIPTION OF THE PREFERRED EMBODIMENTS

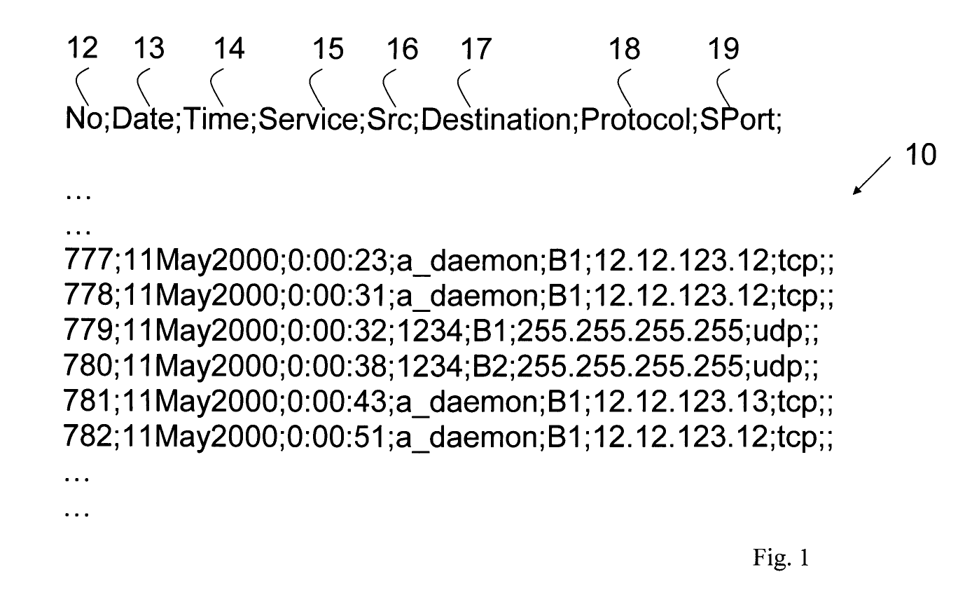

The following non-limiting examples will be described with reference to log data, and therefore FIG. 1 shows an example of log data rows or tuples 10 for an element of a communications system. More particularly, the exemplifying log data describes event information for a firewall that passes communications there through. It is noted that, although only six rows of data (rows 777 to 782) are shown, a database may comprise a huge number of rows, for example millions of rows.

Each row 10 is shown to comprise a number of data fields or data positions 12 to 19. In the example the data positions are for storing information such that position 12 is for the number of the row, position 13 is for information of the date of the event, position 14 is for time of the date, position 15 is for indicating a service the row relates to, position 16 is for indicating where the information is from, position 17 is for indicating a destination address, position 18 is for indication of the used communication protocol, and position 19 is for storing source port information. As evident from FIG. 1, some of the data fields may contain similar information on several rows whereas the information content in some of the fields may change fairly often, even from row to row.

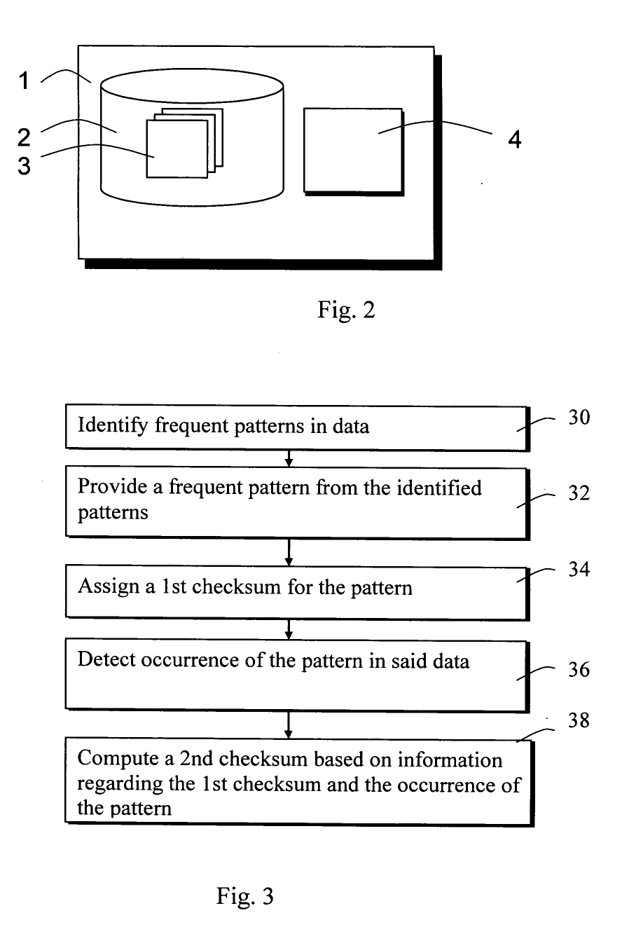

FIG. 2 shows schematically a computerised system 1 comprising at least one data storage 2. The data storage may, for example, include a database arranged to store the exemplifying log data of FIG. 1. The data storage 2 may comprise a plurality of records 3.

In the herein described embodiments a checksum may be computed incrementally during a search for frequent patterns for all candidates during scanning of a database and counting of support for the candidates. The computerised system of FIG. 2 is provided with a data processor 4 for incrementally producing a checksum for a set of position identifiers of transactions where a candidate occurs during a scan. A candidate is commonly considered to occur in a transaction if all attribute values or binary attributes contained in the candidate also occur in the transaction. The scan may be performed over just one data storage entity or a plurality of data storage entities.

The support of a candidate may be calculated in parallel with calculation of the checksum. The support may be defined as being the total number of transactions in the database in which the candidate occurs. Alternatively, the support may be defined as being the relative fraction of transactions in the database in which the candidate occurs. Various processes of calculating the support are known to the skilled person, and therefore not explained.

The data processor 4 may be configured to keep account of checksums of candidates and to compare checksums of candidates to checksums of other candidates and/or checksums of previously found frequent patterns. The data processor 4 may combine a candidate with another candidate. The data processor 4 may also combine a candidate with a previously found frequent pattern. The combining may be performed in response to detection of matching checksums. The checksums can be considered to match if the candidates that are compared occur on exactly the same rows. This is so for example if the checksum is determined by the transaction identifiers (TIDs) of the transactions or tuples where the candidate occurs. If two candidates always occur together, i.e. if one candidate is present in a transaction, also the other candidate can be considered as being present, the lists of transaction identifiers related to the candidates are identical. Thus the checksums that are calculated from the transaction identifier lists match.

The above data processing functions may be provided by means of one or more data processor entities. Appropriately adapted computer program code product may be used for implementing the embodiments, when loaded to a computer, for example for performing the computations and the searching, matching and combining operations. The program code product may be stored on and provided by means of a carrier medium such as a carrier disc, card or tape. A possibility is to download the program code product via a data network.

Unique data position information may be employed for identifying data in the computerised system 1. In principle, any information capable of uniquely identifying the location of a particular set of data may be used as a unique identifier of the data position. Examples of possible unique data position information include transaction identifiers (TIDs), row and/or field numbers, timestamps, unique keys and so on. For example, the position may be expressed as the transaction identifier (TID) of a tuple where a candidate set occurs. Timestamps may be used in certain applications if it can be ensured that each data entry has a different time stamp. Unique identifiers may also be provided by means of at least one transaction field value (a value or a combination of values), or by means of an identifier derived from one of the above referenced identifiers. For example, transactions may be sorted based on timestamps or other identifiers, where after a checksum may be computed for the whole transaction. That checksum for the whole transaction may then be used as a unique identifier.

In accordance with an embodiment shown in the flowchart of FIG. 3, a search is first performed at step 30 to identify frequent patterns, for example frequent data items on data rows. A frequent pattern may then be selected as a candidate set at step 32 from the detected frequent patterns. A checksum may be assigned at step 34 for the frequent pattern. The search is continued to find occurrences of the frequent pattern at step 36. A further checksum is computed at step 38 based on the previous checksum of step 34 and information about an identity associated with the present occurrence of the frequent pattern.

In FIG. 3 embodiment steps 36 and 38 are executed once to produce a second checksum for the frequent pattern. This is, however, may not always be sufficient for calculating valid checksums.

Although a checksum may be calculated for one frequent pattern, in a preferred embodiment steps 32 to 38 may be performed for all frequent sets that were found in step 30. A checksum may thus be computed incrementally based on information of checksums computed previously and the position or another identifier of the latest occurrence of the frequent pattern. In this context the phrase ‘occurrence of a frequent pattern’ refers to an instance of the frequent pattern that occurs in the data. In iterative checksum calculation steps 36 and 38 may be executed iteratively for each occurrence of the frequent pattern in the data. The possibility of running steps 36 and 38 iteratively is not visualised in FIG. 3 for clarity.

The order of transactions may have some relevance in applications wherein more than one database pass are to be compared. It might be necessary to fix the starting point if the checksum chains generated during different database passes are to be compared.

If the checksums of any sets of candidates are equal after the computations are finished, these candidates can be assumed to belong to the same closure of frequent patterns. A closure of frequent patterns may be replaced by one of the patterns belonging to the closure or any other appropriate unique identifier. For example, a closure can be described by means of a pattern belonging to the closure.

The pattern selected as the replacement, i.e. to represent all members of the closure is preferably either a generator or a closed pattern. The generator commonly refers to one of the smallest patterns belonging to the closure of frequent patterns. The closed pattern commonly refers to union of all patterns in the closure of frequent patterns, i.e. a frequent pattern of data, which does not have any superpatterns of data that share the same frequency.

Only the representative of the closure may then need to be expanded in the following rounds of the search algorithm.

During the search phase a checksum of each candidate set and the candidate set may need to be stored in a memory. Thus storing of lists of items occurring together with a candidate or lists of transaction identifiers (TIDs) where a candidate occurs may be avoided. The checksum may be stored for example in a main memory as long as it needs to be accessed during execution of the search algorithm. After the algorithm has been executed, the checksums may be deleted.

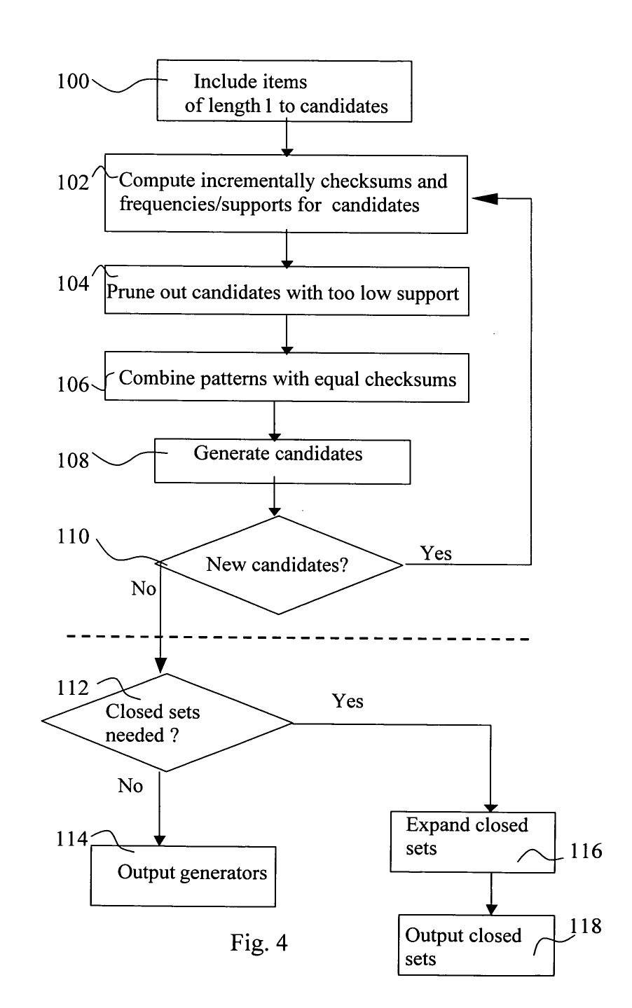

FIG. 4 shows a flowchart for a possible closed pattern computation with incremental checksums. In step 100 item patterns having the length of one are included in a set of candidates. Checksums and frequencies (or supports) are then computed incrementally for each candidate pattern at step 102. Candidates whose supports are below a predefined frequency threshold are pruned out at step 104. Patterns with equal checksums are then combined at step 106, and appropriate candidate sets are generated at step 108. At step 110 it is checked if step 108 produced any new candidates for which no checksum has been computed at step 102. If so, another iteration round is taken and any missing checksums are computed at step 102.

It is noted that the item patterns may also be non-frequent if the algorithm updates frequencies and checksums in step 102 and the pruning at step 104 is done during subsequent iteration.

An aim of the iteration rounds is to eliminate candidates belonging to the same closure and to keep one representative of a closure and to prune i.e. discard the others.

If it is detected that all checksums that are needed are computed, a decision may be made at step 112 if a closed set is needed, or if generators are sufficient. In other words, a selection at this stage may be whether largest sets (closed sets) or the smallest (i.e., generators) of a closure are needed. In the latter case, generators are output at step 114. If closed sets are needed, the generators are expanded at step 116 to form closed sets. The expanded closed sets are then output at step 118. In other words, the algorithm finds generators and outputs the generators at step 114 only if nothing is done. If closed sets are needed, the generators or other representatives may be opened and expanded with the closure information to produce closed sets.

If the iteration round between step 110 and 102 is ignored, the schematic flowchart of the FIG. 4 example can be considered as showing generation of representatives or closed sets as a one-time process. Steps 106 and the output generation step 112 to 118 include the decision to select a representative for each detected closure of frequent sets. It is also noted that generation of closed sets or representatives may be executed during each iteration round between steps 110 and 102. Furthermore, steps 112 to 118 are not needed at all by the search algorithm itself. Calculations concerning the closed sets and representatives such as generators may be included in the loop between steps 102 and 110. Thus steps 112 to 118 are illustrated as being separable from the search algorithm by the dashed line between steps 110 and 112.

In step 106, generators may be advantageously used, but any candidate could be selected from within the closure. Thus also the largest candidate, i.e., the closed set, may be selected. A generator or a closed set of the closure may be selected as the representative also in the output generation step shown below the dashed line, depending on the use of the output.

It shall be appreciated that although generator sets of data and closed sets of data may be commonly considered as the preferred alternatives for the representatives, in principle any pattern from within the closure could be used as a representative. It is also possible to generate the identifier based on a set of data. For example, a generator may be selected, where after an item from the closure is added to the generator, thus making the representative different from the generator but still having properties similar to the generator. It is also possible to replace the closure with an entirely new symbol representing the closure. Therefore it shall be appreciated that although in certain cases it may be preferred to use generators in step 106 and generators or closed sets in the output generation step, depending on the projected use of the results, it does not in principle matter which of the patterns contained in the closure is selected to be the representative.

The search of frequent patterns may be provided by any appropriate algorithm that is suitable for searching for frequent patterns. These include algorithms which compare lists of transaction IDs (TIDs) in order to identify equal supports, for example, sets of tuples where candidate sets occur. The search algorithm may take advantage from the search space reduction between the database passes that is provided by the removal of patterns included in closures after each round. The search space is reduced since the number of candidates is reduced by replacing all patterns belonging to the same closure with merely one representative of that closure.

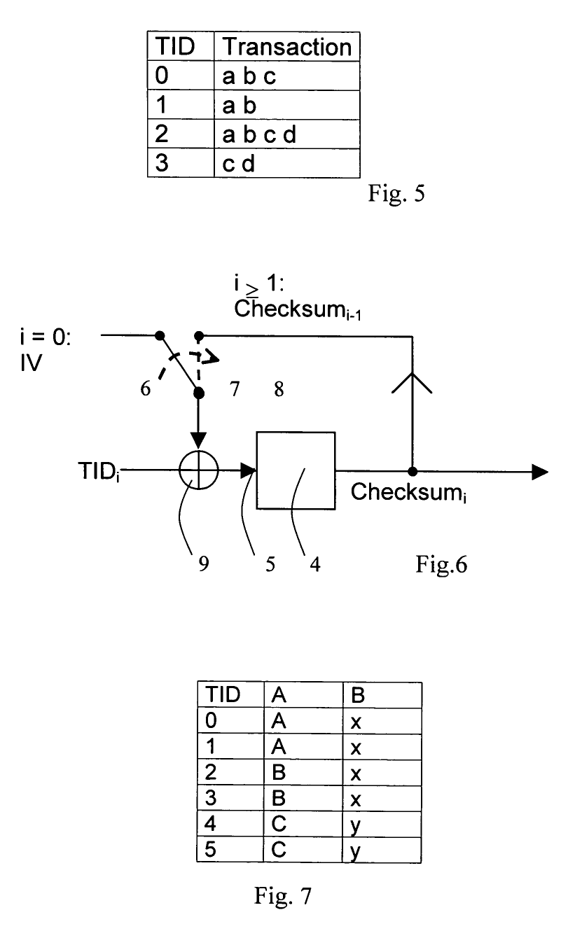

For example, if there is a data set such as the one shown in FIG. 5 and the threshold for frequent patterns is two, the checksum sₐ for candidate {a} may then be as follows:
after the first transaction: s_{a,0}=s(0, Seed),
after the second transaction: s_{a,1}=s(1, s_{a,0}),
after the third transaction: s_{a,2}=s(2, s_{a,1}), and
after the fourth transaction: s_{a,3}=s_{a,2}
   where the ‘Seed’ will be a common constant used for the first occurrences of all candidates.

After the first database pass it may be detected that checksums of values a and b are equal. Therefore, before starting the second pass b can be merged with a to {ab}This value may then be left out from the second pass and only frequent patterns {a}, {c} and {d} may be expanded. This can be done because of the safe assumption that b occurs only when a also occurs.

On the second database pass a set of candidates {{ac}, {ad}, {cd}} is used. This means that all candidates with b have been left out as explained above, in other words, candidates {ab}, {bc} and {bd} are not used.

Item b can be included to all frequent patterns containing a after the search for frequent patterns has been finished. This may be required, for example, if the search is for finding the closed or largest sets of a closure.

An example of a functional entity for checksum computations is shown in FIG. 6. More particularly, a processor 4 is shown to provide a computing function for computing checksums based on information of previous checksums and transactions.

The solid line 6 of FIG. 6 illustrates the initial situation wherein i=0, i.e. no occurrences of a frequent pattern has been found. The dashed line 7 illustrates the situation after at least one occurrence of a frequent pattern is found, i.e. i≧1.

In the latter situation a feedback loop 8 is activated. That is, a previous checksum (i-1) for an ith frequent pattern is fed back via the loop 8 and mixer function 9 to the checksum computing function 4. Thus the input 5 to the computing function 4 comprises unique position information such as a transaction identifier of the ith frequent pattern and the previous checksum (i-1). Thus each new checksum is based also on the values of the previous checksums.

The checksum computing function may be cryptographic. This, however, is by no means necessary.

Although checksum collisions are expected to be substantially rare, the possibility of checksum collisions may need to be considered in certain applications. Any mapping function with a sufficiently low checksum collision probability may be used in the embodiments. The computing function 4 of FIG. 6 can be a hash function that is defined such that the probability of an occasion in which there would be equal checksums for frequent patterns with different sets of transactions where they occur is practically zero.

Checksum collisions can be detected by investigating if candidate item sets actually can be contained in a closure. A simple verification of checksums to exclude collisions may also be used. For example, after a discovery of a closed set, the found set may be compared to the actual data and the correctness of the closed set may be verified by checking if the dependencies expressed by the closed set actually hold in the database. Another possibility to reduce the possibility of checksum collisions and the effects thereof is to calculate two or more checksums in parallel for each candidate, using either different checksum algorithms and/or different seed values. Even if a checksum collision may occur in one of the checksums, it is extremely unlikely that there would be a checksum collision in the other checksum function(s) at the same time. A checksum collision may be detected, for example, when for two candidates one checksum pair matches but another checksum pair does not match. The verification may also be based, for example, on frequencies of frequent patterns and their sub-patterns. This is based on the assumption that two frequent patterns may be in the same closure only if they share the same frequency. If their checksums are equal but the frequencies are unequal there must be a checksum collision.

A non-limiting example of a suitable algorithm that may be used for the above described searching and checksum computing may be based on the so called Apriori algorithm. A description of the Apriori algorithm has been given by Agrawal et al. in article “Fast discovery of Association Rules” published in 1996 in book “Advances in Knowledge Discovery and data Mining”, pages 312 to 314. The Apriori algorithm described by Agrawal et al. needs to be modified so as to introduce the checksum computations therein and to make the algorithm able to take full advantage from the search space reduction. An example of such modified Apriori algorithm is shown below.

| | |
|---|---|
| 1: | L₁ = frequent 1-patterns |
| 2: | for (k = 2; Lₖ₋₁ ≠ ∅; k++) do |
| 3: | Cₖ = apriori-gen(Lₖ₋₁); //New candidates |
| 4: | for all transactions t ∈ D do |
| 5: | Cₜ = subset(Cₖ, t); // Candidates contained in t |
| 6: | for all candidates c ∈ Cₜ do |
| 7: | c.count++; |
| 8: | c.chksum = compute-chksum(t.ID, c.chksum); |
| 9: | end for |
| 10: | end for |
| 11: | Lₖ = {c ∈ Cₖ \| c.count ≧ minsup} |
| 12: | Lₖ = remove-closure-sets(∪ᵢ₌₁^{k-1} Lᵢ, Lₖ); |
| 13: | end for |
| 14: | Lₖ = expand-closed-sets(∪ₖ Lₖ); |
| 15: | return(L); |

In the above specific example D denotes a database of transactions tᵢεD, where i=0, . . . , ∥D∥, where ∥D∥ is the size of the database, and ‘minsup’ defines a minimum threshold for the amount of pattern occurrences for a pattern to be considered frequent.

The above described principles can be used also in algorithms that are for searching for frequent sequences, either ordered or unordered, from a stream of events that has been divided to disjoint buckets of related events. If a bucket corresponds a database transaction, frequent episodes with similar bucket ID lists can be considered as belonging to a closure.

Another possible application of the checksum based searching is searching of functional dependencies (FDs) between database columns. An example of this is now explained with reference to FIG. 7. If transaction identifier (TID) lists of all values aᵢ of variable A and if all TID lists of different value pairs aᵢbⱼ, of variables A and B are equal, then there exists a functional dependency A to B. A functional dependency holds between database columns A and B (A to B), if for all the values aᵢ of column A there exists only one value bⱼ of column B, such that aᵢ and bⱼ occur in the same transactions. This kind of dependencies can be found by computing corresponding incremental checksums first for all value combinations and then for the list of value combinations checksums and by comparing these to each other. If a value combination checksum of two groups of variables equals they introduce a similar partitioning of a database and hold functional dependency between some of their items.

For example, for the data set given above, the checksums of a, b and c are s_{a,1}, s_{b,3} and s_{c,5}, respectively. A checksum computed from all of s(s_{a,1}, s_{b,3}, s_{c,5}) equals to a checksum of all the pairs aᵢ,bⱼ, i.e., s(s_{ax,1}, s_{bx,3}, s_{cy,5}). Thus it can be concluded that there is a functional dependency A to B.

It is possible to use transaction identifiers in checksum calculation in random order rather than in fixed order. This may require that only those candidates whose frequency and checksums are updated during the same database pass are to be compared. Candidates whose information has been updated during previous passes may not be comparable to the checksums of the most recent pass if random order is used. On the other hand, if the order of transactions is fixed and unambiguous during all database passes checksums computed during different passes can be compared to each other.

Rather than searching over an entire database, a database may be divided into blocks. The blocks may then be searched individually. The division may be needed for example if a database includes data which cannot be, for some reason, searched based on checksums as described above. The searching of the database may be made nevertheless quicker by means of separating such data into a block which is analyzed by a more appropriate manner while at least a part of the other blocks are processed by employing the incremental checksums as described above. This should provide advantage in the overall efficiency of the search functions, as data that needs to be processed with less efficient methods can be separated in one or only few smaller data blocks.

In the embodiments occurrences of a frequent pattern may be incrementally presented by means of a checksum. The checksum can be compared with checksums of other patterns in order to find out whether the supports of the patterns are equal or not. The incremental construction of the checksum representation for a list may enable a search mechanism wherein longer representations of number lists are not needed during computations. This may help in scaling up a search algorithm. The conventional ways of presenting lists may take considerably more memory space than a single integer, such as a single checksum. Also comparison of two integers, i.e. checksums, is expected to be a substantially faster process than the conventional processes of comparing two lists given in any other representation.

The embodiments can be utilised in providing a method and apparatus for computing closed frequent patterns from a constant stream of log entries. The embodiments may also be used for finding association rules and frequent episodes.

It shall be understood that although the above example is described with reference to log data similar principles are applicable to any data and any computerised system.

It is noted herein that while the above describes exemplifying embodiments of the invention, there are several variations and modifications which may be made to the disclosed solution without departing from the scope of the present invention as defined in the appended claims.

1. A method for processing data in a computerized system, the method comprising the steps of:
providing a frequent pattern of data from patterns of data;
assigning a first checksum for the frequent pattern of data;
detecting an occurrence of the frequent pattern of data in data provided in a computerized system; and
computing a second checksum based on information regarding the first checksum and information regarding the occurrence of the frequent pattern of data in said data.

2. The method as claimed in claim 1, further comprising:
computing further checksums for frequent patterns of data with occurrences in said data based on information regarding previous checksums and information regarding occurrences of the frequent patterns.

3. The method as claimed in claim 1, further comprising the step of:
comparing at least two checksums with each other.

4. The method as claimed in claim 3, further comprising the steps of:
finding at least two frequent patterns with matching checksums; and
concluding, in the step of comparing, that said at least two frequent patterns belong to a closure of frequent patterns.

5. The method as claimed in claim 4, further comprising:
providing a representative of the closure of frequent patterns using a unique identifier.

6. The method as claimed in claim 5, further comprising:
generating the representative of the closure of frequent patterns based on a generator set of data.

7. The method as claimed in claim 5, further comprising:
generating the representative of the closure of frequent patterns based on a closed set of data.

8. The method as claimed in claim 6, further comprising the step of:
expanding the representative.

9. The method as claimed in claim 5, wherein, in the step of providing the representative, using the unique identifier comprises using a symbol as the representative of the closure of frequent patterns.

10. The method as claimed in claim 1, further comprising:
counting of support for all candidate sets during scanning of the data provided in the computerized system.

11. The method as claimed in claim 1, further comprising:
providing information regarding an occurrence of a candidate set using a unique identifier.

12. The method as claimed in claim 11, further comprising:
providing the unique identifier using at least one of a transaction identifier, a position identifier, a timestamp, a row number, a field number, and a unique key.

13. The method as claimed in claim 11, further comprising:
providing the unique identifier using at least one transaction field value.

14. The method as claimed in claim 11, further comprising:
providing the unique identifier by means of an identifier derived from at least one of a transaction identifier, a position identifier, a timestamp, a row number, a field number, and a unique key.

15. The method as claimed in claim 1, further comprising:
providing the information regarding the occurrence of the frequent pattern based upon information regarding position of the occurrence.

16. The method as claimed in claim 1, further comprising the step of:
checking for any colliding checksums.

17. The method as claimed in claim 1, further comprising the steps of:
dividing a database into at least two sections; and
processing only selected sections from the database.

18. The method as claimed in claim 1, further comprising:
storing checksums until data processing is finished.

19. The method as claimed in claim 1, further comprising:
processing fixedly ordered transactions.

20. The method as claimed in claim 1, further comprising:
processing randomly ordered transactions.

21. The method as claimed in claim 1, further comprising:
computing closed frequent patterns from a stream of data entries.

22. The method as claimed in claim 1, further comprising:
finding association rules from data entries.

23. The method as claimed in claim 1, further comprising:
finding frequent episodes from data entries.

24. The method as claimed in claim 1, further comprising:
discovering functional dependencies from the data.

25. The method as claimed in claim 1, further comprising:
processing log data.

26. A computer program embodied on a computer readable medium, the computer program controlling a computer to execute a process comprising:
providing a frequent pattern of data from patterns of data;
assigning a first checksum for the frequent pattern of data;
detecting an occurrence of the frequent pattern of data in data provided in a computerized system; and
computing a second checksum based on information regarding the first checksum and information regarding the occurrence of the frequent pattern of data in said data.

27. A computerized system comprising:
at least one processor for processing data, the at least one processor being configured to provide a frequent pattern from patterns of data, to assign a first checksum for the frequent pattern, to monitor for an occurrence of the frequent pattern in said data, and to compute a second checksum based on information regarding the first checksum and information regarding the occurrence of the frequent pattern in said data.

28. The computerized system as claimed in claim 27, wherein the at least one processor is further configured to compute iteratively further checksums for frequent patterns of data with occurrences in said data based on information regarding previous checksums and information regarding occurrences of the frequent patterns.

29. A processor for a computerized system, the processor being configured to provide a frequent pattern from patterns of data, to assign a first checksum for the frequent pattern, to monitor for an occurrence of the frequent pattern in data, and to compute a second checksum based on information regarding the first checksum and information regarding the occurrence of the frequent pattern in said data.

30. The processor as claimed in claim 29, the processor being further configured to compute iteratively further checksums for frequent patterns of data with occurrences in said data based on information regarding previous checksums and information regarding occurrences of the frequent patterns.

31. A computerized system, comprising:
providing means for providing a frequent pattern of data from patterns of data;
assigning means for assigning a first checksum for the frequent pattern of data;
detecting means for detecting an occurrence of the frequent pattern of data in data provided in a computerized system; and
computing means computing a second checksum based on information regarding the first checksum and information regarding the occurrence of the frequent pattern of data in said data.
